(19) United States
(12) Patent Application Publication
(10) Pub. No.: US 2026/0264163 A1
(43) Pub. Date: Sep. 10, 2026

(54) RESISTANCE WELDING DEVICE AND RESISTANCE WELDING METHOD

(71) Applicant: MAZDA MOTOR CORPORATION, Hiroshima (JP)

(72) Inventors: Kojiro YAMAGUCHI, Aki-gun, Hiroshima (JP); Kouji SATO, Aki-gun, Hiroshima (JP); Motonori MORIWAKI, Aki-gun, Hiroshima (JP); Tomoyuki IWAMOTO, Aki-gun, Hiroshima (JP); Hiroki SATO, Aki-gun, Hiroshima (JP); Naoki UJIHIRA, Aki-gun, Hiroshima (JP)

(73) Assignee: MAZDA MOTOR CORPORATION, Hiroshima (JP)

(21) Appl. No.: 18/994,844

(22) PCT Filed: Mar. 24, 2023
(86) PCT No.: PCT/JP2023/011790

§ 371 Date: Jan. 15, 2025

(30) Foreign Application Priority Data
Aug. 8, 2022 (JP) 2022-126153

(51) Int. Cl. B23K 11/11; B23K 103/04; B23K 103/10

(52) U.S. Cl. CPC B23K 11/115; B23K 2103/04; B23K 2103/10

(57) ABSTRACT

A resistance welding device 1 includes a first electrode 2 and a second electrode 3, the first electrode has a first contact surface 21 in contact with a workpiece 100, the second electrode has a second contact surface 31 in contact with the workpiece, the first contact surface has at least one first overlapping portion 22 and at least one first non-overlapping portion 23, the second contact surface has a second overlapping portion 32 and at least one second non-overlapping portion 33, and the first overlapping portion and the second overlapping portion overlap with each other in the stacking direction, and the first non-overlapping portion and the second non-overlapping portion do not overlap with each other in the stacking direction.

### DESCRIPTION

### Technical Field

The technique disclosed herein relates to a resistance welding device and a resistance welding method.

### Background Art

Patent Document 1 describes an electrode for resistance spot welding. This welding electrode is used for one-side resistance spot welding. In the one-side resistance spot welding for a workpiece including a first plate member and a second plate member, the welding electrode contacts the surface of the first plate member to apply pressure to the first plate member, and an earth electrode is connected to the second plate member to distribute power to the second plate member. When current flows between the welding electrode and the earth electrode, a nugget is formed at a joint point between the first plate member and the second plate member. In the one-side resistance spot welding, the welding electrode and the earth electrode do not necessarily face each other, and for this reason, as illustrated in the drawings of Patent Document 1, a power distribution path in the workpiece may not coincide with the direction of pressurization with the electrode.

Patent Document 2 describes a resistance welding device including a first electrode and a second electrode. Each of the first electrode or the second electrode includes an inner electrode and an outer electrode. The resistance welding device first softens at least one of multiple welding target members by distributing power between the inner electrodes and/or the outer electrodes in a state in which one of an inner pressure or an outer pressure is greater than the other pressure, and after the softening, welds the welding target members to each other at a portion at which the inner pressure acts by distributing power between the inner electrodes and/or the outer electrodes in a state in which the inner pressure is greater than the outer pressure. This resistance welding device is suitable for welding, for example, an iron-based member and an aluminum-based member because poor joint is less likely to occur.

### CITATION LIST

### Patent Document

Patent Document 1: Japanese Unexamined Patent Publication No. 2012-55925
Patent Document 2: Japanese Unexamined Patent Publication No. 2021-41441

### SUMMARY

### Technical Problem

Various materials have been used in motor vehicle bodies, for example, for the purpose of weight reduction and/or function optimization. Accordingly, a multi-material joining technique has been required. The welding technique described in Patent Document 2 is one of the multi-material joining techniques.

A proper joint interface state in the multi-material welding stabilizes a welding quality. The joint interface state described here includes, for example, the melting amount or the joint interface temperature of each material. In order to stabilize the multi-material welding quality, it is necessary to manage the joint interface state with high accuracy.

The tip end shape of the electrode used for the so-called spot welding changes due to, for example, abrasion when the welding is repeated. Hereinafter, the state change in the electrode tip end due to the abrasion or other factors will be collectively referred to as deterioration of the electrode. The deterioration of the electrode changes the power distribution path in the workpiece, and the change in the power distribution path changes a current density. When the current density changes, a heat generation state at the joint interface changes. The deterioration of the electrode makes it difficult to manage the joint interface state with high accuracy, and makes the multi-material welding quality unstable.

The deterioration of the electrode also causes the following inconvenience in not only the multi-material welding but also the resistance welding in general. That is, in the conventional spot welding technique, the heat generation state changes each time due to the deterioration of the electrode, so that the change in the heat generation state is allowed within a range in which a desired welding quality can be ensured. When the number of times of welding exceeds the predetermined number of times, the desired welding quality cannot be ensured, so that the electrode is dressed or replaced. For maintenance of the electrode, a manufacturing line must be stopped. If the electrode is easily deteriorated, the frequency of stopping the manufacturing line increases. In addition, the amount of power supplied during the welding may be increased in advance so that the desired quality can be ensured even when the electrode is deteriorated. A great power supply amount leads to an energy loss.

The technique disclosed herein reduces the deterioration of the electrode used for the

### Solution to the Problems

The inventors of the present invention have studied the mechanism of the deterioration of the electrode in the resistance welding. FIG. 15 illustrates a state in which a conventional resistance welding device 10 welds a workpiece 100. The resistance welding process includes the following steps (1) to (4).
(1) The workpiece 100 including multiple stacked welding target members 101, 102 is sandwiched between a first electrode 20 and a second electrode 30 attached to a welding gun and is pressurized in a stacking direction, and then, power is supplied to the workpiece 100 through the first electrode 20 and the second electrode 30 (see an arrow indicated by a broken line in FIG. 15). The stacking direction corresponds to an upward-downward direction in the plane of paper of FIG. 15. In the resistance welding device 10 of FIG. 15, the pressurization direction and the power supply direction coincide with each other.
(2) Joule heat is generated at a joint interface 103 in the workpiece 100 to heat the workpiece 100, and part of the heat is transmitted to the first electrode 20 and the second electrode 30 to cool the workpiece 100.
(3) The workpiece 100 is softened and melted by the heat, and is plastically deformed.
(4) Molten metal at the joint interface 103 of the workpiece 100 is solidified and a nugget is formed accordingly, and the welding of the workpiece 100 is completed.

According to the studies of the inventors of the present invention, it was found that when the workpiece was plastically deformed in the step (3), arc discharge occurred between an electrode surface and a workpiece surface, which causes the deterioration of the electrode. More specifically, an arm of the welding gun is bent during the pressurization of the workpiece. When the workpiece is plastically deformed and the electrode sinks into the workpiece, the stress of the arm is released. The electrode may slip on the workpiece surface or may tilt with respect to the workpiece surface due to the stress release. As a result, the state of contact between the electrode and the workpiece surface changes. The change in the state of contact between the electrode and the workpiece surface rapidly changes a current path between the electrode and the workpiece, so that the arc discharge occurs between the electrode surface and the workpiece surface.

Since new finding about the mechanism of the deterioration of the electrode was obtained, the inventors of the present invention focused on reducing the change in the state of contact between the electrode and the workpiece surface when the workpiece is plastically deformed. The inventors of the present invention have devised an electrode structure to complete the technique disclosed herein.

Specifically, as illustrated in FIG. 15, in the conventional resistance welding device 10, the first electrode 20 and the second electrode 30 integrally perform the pressurization on and the power supply to the workpiece 100. Thus, when the first electrode 20 and the second electrode 30 pressurizing the workpiece 100 sink into the workpiece 100 along with the plastic deformation of the workpiece 100, the state of contact between the first electrode 20 and the workpiece 100 and the state of contact between the second electrode 30 and the workpiece 100 change along with the sinking.

Thus, the inventors of the present invention have reduced the sinking of the first electrode and/or the second electrode into the workpiece by separating the pressurization function and the power supply function of the first electrode and the second electrode.

The technique disclosed herein relates to a resistance welding device for welding multiple stacked welding target members of a workpiece by pressurizing the workpiece in a stacking direction while supplying power to the workpiece. The resistance welding device includes a first electrode located on a first side in the stacking direction with respect to the workpiece, and a second electrode located on a second side in the stacking direction with respect to the workpiece and sandwiching the workpiece together with the first electrode, the first electrode has a first contact surface in contact with the workpiece, the second electrode has a second contact surface in contact with the workpiece, the first contact surface has at least one first overlapping portion and at least one first non-overlapping portion, the second contact surface has at least one second overlapping portion and at least one second non-overlapping portion, and the first overlapping portion and the second overlapping portion overlap with each other in the stacking direction, and the first non-overlapping portion and the second non-overlapping portion do not overlap with each other in the stacking direction.

According to this configuration, the first electrode and the second electrode of the resistance welding devices pressurizes the workpiece in the stacking direction while supplying power to the workpiece.

The first electrode has the first contact surface in contact with the workpiece, and the first contact surface has at least one first overlapping portion and at least one first non-overlapping portion. As in the first electrode, the second electrode also has the second contact surface in contact with the workpiece, and the second contact surface has at least one second overlapping portion and at least one second non-overlapping portion.

The first overlapping portion and the second overlapping portion overlap with each other in the stacking direction. The term “overlap in the stacking direction” means that the first overlapping portion and the second overlapping portion overlap with each other when the second electrode (or the first electrode) is viewed from the first electrode side (or the second electrode side) along an axis extending in the stacking direction, and does not mean that the first overlapping portion and the second overlapping portion are in direct contact with each other. When the first electrode and the second electrode sandwich and pressurize the workpiece, the first overlapping portion and the second overlapping portion face each other in the stacking direction and form a pressurizing portion which actually pressurizes the workpiece. In the first electrode and the second electrode, the portion which actually pressurizes the workpiece is part of the first contact surface and the second contact surface, and the area of the first overlapping portion and the second overlapping portion is smaller than the area of the entirety of the first contact surface and the second contact surface. The first overlapping portion and the second overlapping portion may or may not have a function of supplying power to the workpiece.

The first non-overlapping portion and the second non-overlapping portion do not overlap with each other in the stacking direction. When the first electrode and the second electrode sandwich and pressurize the workpiece, the first non-overlapping portion and the second non-overlapping portion do not pressurize the workpiece at all or much. The first non-overlapping portion and the second non-overlapping portion mainly function as a power supply portion which supplies power to the workpiece.

In this resistance welding device, each of the first electrode or the second electrode is separated into the function of pressurizing the workpiece and the function of supplying power to the workpiece.

When the first electrode and the second electrode sandwich and pressurize the workpiece and power is supplied to the workpiece, the welding target members come into contact with each other at a joint interface corresponding to the first overlapping portion and the second overlapping portion, and a power distribution path is formed. Joule heat is generated at such a portion, and the workpiece is softened and melted. An area where the workpiece is softened and melted is approximately an area corresponding to the first overlapping portion and the second overlapping portion. When the workpiece is plastically deformed due to the softening and melting of the workpiece, the area of the entirety of the first contact surface and the second contact surface is relatively greater than the area of the first overlapping portion and the second overlapping portion in each of the first electrode or the second electrode. This reduces the first electrode and the second electrode from sinking into the workpiece. Since a change in the state of contact between the electrode and the workpiece surface is reduced, occurrence of arc discharge between the electrode and the workpiece is reduced. That is, the deterioration of the electrode is reduced.

The first overlapping portion and the second overlapping portion of the first electrode and the second electrode of the above-described configuration have relatively-small areas, and therefore, the amount of heat transferred from the workpiece to the first electrode or the second electrode is reduced. In addition, the volumes of the first electrode and the second electrode having the first non-overlapping portion and the second non-overlapping portion are relatively large, and therefore, the heat capacity of the first electrode or the second electrode is relatively high. As a result, the first electrode and the second electrode are kept from becoming too hot due to the heat from the workpiece, and the deterioration of the electrode, such as alloying of the electrode surface or deformation of the electrode surface, is also substantially prevented.

As a result of the reduction in the deterioration of the electrode, the resistance welding device can manage a joint interface state with high accuracy. This resistance welding device stabilizes, for example, the welding quality of a multi-material. Further, in this resistance welding device, the frequency of stopping a manufacturing line is reduced, which is advantageous in reducing a manufacturing cost. In addition, it is not necessary to increase the amount of power supplied during welding in advance in consideration of the deterioration of the electrode, and therefore, the resistance welding device can also reduce an energy loss.

The first non-overlapping portion and the second non-overlapping portion are stably in contact with the surface of the workpiece without sinking into the workpiece during the welding process. When the welding target members are thermally expanded due to the softening and melting of the workpiece, the first non-overlapping portion and the second non-overlapping portion press the thermally-expanded welding target members. This resistance welding device can reduce distortion of the workpiece after completion of the welding.

Each of the first contact surface and the second contact surface includes the overlapping portion and the non-overlapping portion, and therefore, has a relatively-large area. Each of the first electrode or the second electrode can be stably in contact with the workpiece surface without tilting with respect to the workpiece surface. The stable contact of the electrode achieves stable pressurization and stable power supply by the first electrode and the second electrode. The stable pressurization and the stable power supply are advantageous in stabilization of the welding quality.

A line connecting the first non-overlapping portion and the second non-overlapping portion may intersect a line connecting the first overlapping portion and the second overlapping portion in the vicinity of the joint interface of the workpiece.

A portion where the line connecting the first overlapping portion and the second overlapping portion and the joint interface of the workpiece intersect is a portion where the welding target members come into contact with each other by the pressurization with the first overlapping portion and the second overlapping portion and the power distribution path is formed accordingly, and this portion is a portion to be welded. The line connecting the first non-overlapping portion and the second non-overlapping portion, which supply power to the workpiece, intersects the portion to be welded, where the power distribution path is formed, and accordingly, the first electrode and the second electrode can efficiently generate Joule heat at the portion to be welded in the workpiece. The resistance welding device achieves both the stabilization of the resistance welding and the reduction in the deterioration of the electrode.

The first non-overlapping portion may be located on a first side in a direction orthogonal to the stacking direction with respect to the first overlapping portion, and the second non-overlapping portion may be located on a second side in the direction orthogonal to the stacking direction with respect to the second overlapping portion, and the first non-overlapping portion and the second non-overlapping portion may be located on both sides of the line connecting the first overlapping portion and the second overlapping portion in the direction orthogonal to the stacking direction.

The first non-overlapping portion and the second non-overlapping portion are located on both sides of the line connecting the first overlapping portion and the second overlapping portion in the direction orthogonal to the stacking direction, and therefore, the first electrode and the second electrode can stably contact the workpiece surface.

The first contact surface may have a circular shape, and the second contact surface may have a circular ring shape concentric with the first contact surface, the first overlapping portion may have a circular ring shape located at an outer peripheral portion of the first contact surface, and the first non-overlapping portion may have a circular shape located inside the circular ring-shaped first overlapping portion, and the second overlapping portion may have a circular ring shape located at an inner peripheral portion of the second contact surface, and the second non-overlapping portion may have a circular ring shape located outside the circular ring-shaped second overlapping portion.

According to this configuration, the shape of the power distribution path formed at the joint interface of the workpiece is a circular ring shape. This electrode can uniformly heat the portion to be welded entirely circumferentially.

The first contact surface may have a triangular shape, and the second contact surface may have a triangular shape obtained by inverting the direction of the triangle of the first contact surface with respect to the line connecting the first overlapping portion and the second overlapping portion, and the first contact surface and the second contact surface may be located such that the centers of gravity of the triangles thereof overlap with each other in the stacking direction.

The triangles inverted from each other overlap with each other, and therefore, the first non-overlapping portions are each formed in the vicinity of three vertices of the triangle, and the second non-overlapping portions are also each formed in the vicinity of three vertices of the triangle. The power distribution path formed at the joint interface by the pressurization with the first overlapping portion and the second overlapping portion is located so as to surround the line connecting the first overlapping portion and the second overlapping portion in the circumferential direction. The portion to be welded is uniformly heated entirely circumferentially, and therefore, the quality of the resistance welding is stabilized.

The position of the center of gravity of the first contact surface may be included in the first overlapping portion, and the position of the center of gravity of the second contact surface may be included in the second overlapping portion.

The position of the center of gravity of the first contact surface and the position of the center of gravity of the second contact surface are included in the overlapping portions of the first electrode and the second electrode in the stacking direction, and therefore, a pressure density when the first electrode and the second electrode pressurize the workpiece in the stacking direction is increased. A high pressure density is advantageous in improving the joint quality of the workpiece.

The area of the first contact surface may be 120% or more of the area of the first overlapping portion, and the area of the second contact surface may be 120% or more of the area of the second overlapping portion.

When the area of the first overlapping portion with respect to the entire first contact surface is large, the position of the center of gravity of the first contact surface is likely to be included in the first overlapping portion. In a case where the area of the first overlapping portion is large, the area of the first non-overlapping portion is small. When the area of the first non-overlapping portion is small, the pressurization function and the power supply function of the first electrode as described above are not substantially separated. The same also applies to the second contact surface.

When the area of the first contact surface is 120% or more of the area of the first overlapping portion, the area of the first non-overlapping portion can be sufficiently increased. The first electrode can ensure the high pressure density described above while separating its pressurization function and power supply function.

Similarly, in the second electrode, the area of the second contact surface is 120% or more of the area of the second overlapping portion, and therefore, the area of the second non-overlapping portion can be sufficiently increased. The second electrode can ensure the high pressure density described above while separating its pressurization function and power supply function.

The upper limit of the area of the first contact surface and the upper limit of the area of the second contact surface are determined by such a limitation that the position of the center of gravity of the first contact surface is included in the first overlapping portion and the position of the center of gravity of the second contact surface is included in the second overlapping portion.

Another resistance welding device disclosed herein includes a first electrode located on a first side in a stacking direction with respect to a workpiece and having a first contact surface in contact with the workpiece, and a second electrode located on a second side in the stacking direction with respect to the workpiece, having a second contact surface in contact with the workpiece, and sandwiching the workpiece together with the first electrode, the first electrode has, at part of the first contact surface, a first reduction portion configured to reduce sinking into the workpiece during power supply, and the second electrode has, at part of the second contact surface, a second reduction portion configured to reduce sinking into the workpiece during power supply.

With such a configuration, the sinking of the first electrode having the first reduction portion into the workpiece is reduced, and the sinking of the second electrode having the second reduction portion into the workpiece is also reduced. A change in the state of contact between the electrode and the workpiece surface is reduced, and therefore, occurrence of arc discharge between the electrode surface and the workpiece surface is reduced. That is, the deterioration of the electrode is reduced.

The technique disclosed herein relates to a resistance welding method for welding, using a first electrode and a second electrode, multiple stacked welding target members of a workpiece by pressurizing the workpiece in a stacking direction while supplying power to the workpiece. In this resistance welding method, the first electrode has a first contact surface that is in contact with the workpiece and includes at least one first overlapping portion and at least one first non-overlapping portion, the second electrode has a second contact surface that is in contact with the workpiece and includes at least one second overlapping portion and at least one second non-overlapping portion, the first overlapping portion and the second overlapping portion overlap with each other in the stacking direction, and the first non-overlapping portion and the second non-overlapping portion do not overlap with each other in the stacking direction, and the resistance welding method includes pressurizing the workpiece in the stacking direction with the first overlapping portion and the second overlapping portion, and supplying power to the workpiece by at least the first non-overlapping portion and the second non-overlapping portion.

According to the resistance welding method, when the first electrode and the second electrode pressurize the workpiece while supplying power to the workpiece, and the workpiece is plastically deformed due to softening and melting of the workpiece, sinking of the first electrode and the second electrode into the workpiece is reduced. A change in the state of contact between the electrode and the workpiece surface is reduced, and therefore, occurrence of arc discharge between the electrode surface and the workpiece surface is reduced. That is, the deterioration of the electrode is reduced.

As a result of the reduction in the deterioration of the electrode, the resistance welding method stabilizes, for example, the welding quality of a multi-material. Further, this resistance welding method is advantageous in reducing the frequency of stopping a manufacturing line and reducing a manufacturing cost. Further, it is not necessary to increase the amount of power supplied in advance in consideration of the deterioration of the electrode, and therefore, the resistance welding method can also reduce an energy loss.

### Advantages of the Invention

The resistance welding device and the resistance welding method can reduce the deterioration of the electrode.

### BRIEF DESCRIPTION OF DRAWINGS

FIG. 1 illustrates the entirety of a resistance welding device.

FIG. 2 illustrates a state in which the resistance welding device welds a workpiece.

FIG. 3 illustrates a welding process by the resistance welding device.

FIG. 4 illustrates a first electrode and a second electrode.

FIG. 5 illustrates a first electrode and a second electrode.

FIG. 6 illustrates a first electrode and a second electrode.

FIG. 7 illustrates a first electrode and a second electrode.

FIG. 8 illustrates a first electrode and a second electrode.

FIG. 9 illustrates a first electrode and a second electrode.

FIG. 10 illustrates a first electrode and a second electrode.

FIG. 11 illustrates a first electrode and a second electrode.

FIG. 12 illustrates a first electrode and a second electrode.

FIG. 13 illustrates a state in which the resistance welding device including the first electrode and second electrode illustrated in FIG. 12 welds the workpiece.

FIG. 14 illustrates a change in an inter-electrode resistance value in the case of a conventional electrode and a change in an inter-electrode resistance value in the case of the electrode of FIG. 4.

FIG. 15 illustrates a conventional resistance welding device.

### DESCRIPTION OF EMBODIMENTS

Hereinafter, embodiments of a resistance welding device and a resistance welding method will be described with reference to the drawings. The resistance welding device and the resistance welding method described herein are examples.

### Overall Structure of Resistance Welding Device

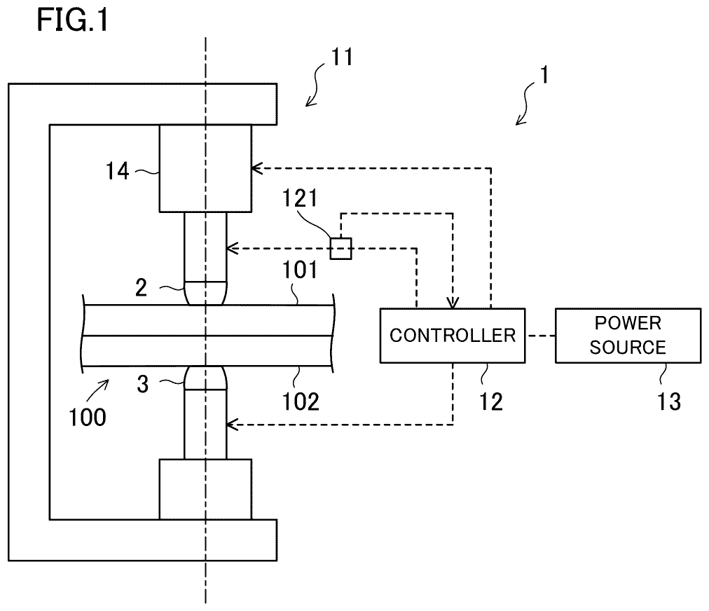

FIG. 1 illustrates, as an example, the entirety of a resistance welding device 1. The resistance welding device 1 pressurizes a workpiece 100 including multiple stacked welding target members 101, 102 in a stacking direction and supplies power to the workpiece 100, thereby welding the welding target members 101, 102. The resistance welding device 1 is a so-called spot welding device. In the resistance welding device 1 of FIG. 1, the stacking direction is an upward-downward direction in the plane of paper. The stacking direction is not limited to the upward-downward direction.

The two welding target members 101, 102 are metal plates, and for example, one is an iron-based member and the other is an aluminum-based member. The iron-based member is, for example, a steel member with high strength and rigidity as in high-tensile steel, and the aluminum-based member is, for example, an aluminum alloy member. Both the welding target members 101, 102 may be iron-based members. In the example of FIG. 1, the workpiece 100 includes the two welding target members 101, 102, but the workpiece 100 may include three or more welding target members. In FIG. 1, the two welding target members 101, 102 have the same thickness, but the welding target members 101, 102 may have different thicknesses.

The resistance welding device 1 illustrated in FIG. 1 includes at least a welding gun 11, a controller 12, and a power source 13.

The welding gun 11 is supported by, for example, a robot (not illustrated). The robot locates the welding gun 11 at a position of the workpiece 100 at which welding is performed.

The welding gun 11 supports a first electrode 2 and a second electrode 3. The first electrode 2 is located on a first side in the stacking direction with respect to the workpiece 100. In FIG. 1, the first electrode 2 is located on the upper side of the workpiece 100. The second electrode 3 is located on a second side in the stacking direction with respect to the workpiece 100. In FIG. 1, the second electrode 3 is located on the lower side of the workpiece 100. The first electrode 2 and the second electrode 3 sandwich the workpiece 100 in the stacking direction, and pressurize the workpiece 100 in the stacking direction.

The first electrode 2 has a columnar shape extending in the stacking direction. The second electrode 3 also has a columnar shape extending in the stacking direction. The first electrode 2 and the second electrode 3 face each other in the stacking direction.

The welding gun 11 has a pressurizing device 14. The pressurizing device 14 moves the first electrode 2 in the stacking direction relative to the workpiece 100. The pressurizing device 14 includes, for example, an air cylinder, a hydraulic cylinder, or a servo motor. The welding gun 11 moves the first electrode 2 by the pressurizing device 14 in a state in which the tip end of the second electrode 3 is in contact with the surface of the workpiece 100, and accordingly, the first electrode 2 and the second electrode 3 can sandwich the workpiece 100 in the stacking direction and pressurize the workpiece 100 in the stacking direction.

The controller 12 controls pressurization on and power supply to the workpiece 100 in the resistance welding device 1. The controller 12 is a controller based on a well-known microcomputer, and includes a central processing unit (CPU), a memory, and an input/output bus. The CPU is a central processing unit that executes a computer program. The computer program includes a basic control program such as an operating system (OS) and an application program activated on the OS to implement a specific function. The memory includes a random access memory (RAM) and a read only memory (ROM). The ROM stores, e.g., various computer programs and data. The RAM is a memory in which a processing area used when the CPU performs a series of processing is provided. The input/output bus inputs and outputs an electric signal to and from the controller 12.

The controller 12 outputs a control signal to the pressurizing device 14 in accordance with a control program stored in the ROM, thereby pressurizing the workpiece 100 using the first electrode 2 and the second electrode 3.

The controller 12 also supplies a welding current from the power source 13 to the workpiece 100 through the first electrode 2 and the second electrode 3. A current sensor 121 outputs a measurement signal corresponding to the welding current to the controller 12. The controller 12 can obtain an electrical resistance value between the first electrode 2 and the second electrode 3 from the measurement signal from the current sensor 121. The controller 12 adjusts the welding current supplied to the workpiece 100 based on the electrical resistance value between the first electrode 2 and the second electrode 3.

### Basic Structure of First Electrode and Second Electrode

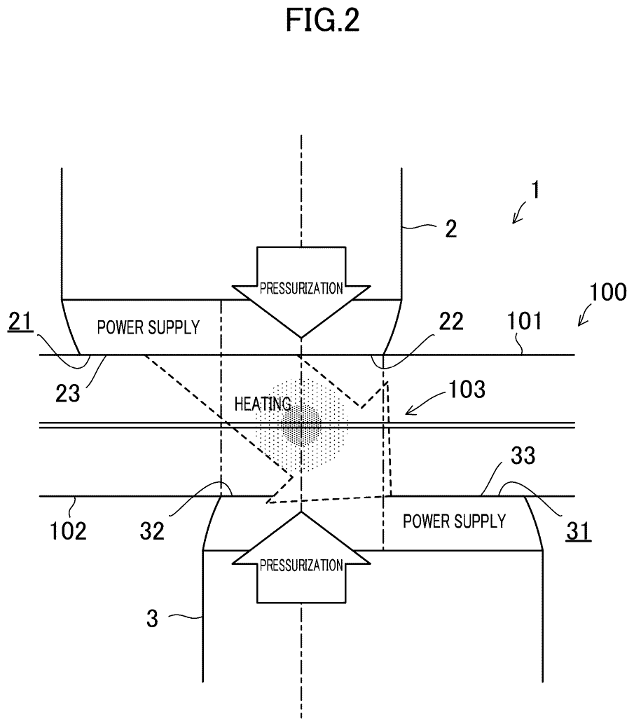

FIG. 2 illustrates, as an example, a basic structure of the first electrode 2 and the second electrode 3. The first electrode 2 and the second electrode 3 have such a feature that the pressurization function and the power supply function are separated.

The first electrode 2 has a first contact surface 21. The first contact surface 21 is in contact with the surface of the workpiece 100, more specifically the surface of the welding target member 101. The first contact surface 21 is, for example, a flat surface. The first contact surface 21 is not limited to the flat surface.

The first contact surface 21 has a first overlapping portion 22 and a first non-overlapping portion 23. That is, the first overlapping portion 22 is a portion of the first contact surface 21, and the first non-overlapping portion 23 is a portion of the first contact surface 21 other than the first overlapping portion 22.

The second electrode 3 has a second contact surface 31. The second contact surface 31 is also in contact with the surface of the workpiece 100, more specifically the surface of the welding target member 102. The second contact surface 31 is, for example, a flat surface. The second contact surface 31 is not limited to the flat surface.

The second contact surface 31 has a second overlapping portion 32 and a second non-overlapping portion 33. That is, the second overlapping portion 32 is a portion of the second contact surface 31, and the second non-overlapping portion 33 is a portion of the second contact surface 31 other than the second overlapping portion 32.

The first overlapping portion 22 and the second overlapping portion 32 overlap with each other in the stacking direction (see a two-dot chain line in FIG. 2). The first non-overlapping portion 23 and the second non-overlapping portion 33 do not overlap with each other in the stacking direction. More specifically, the first non-overlapping portion 23 is located on a first side in a direction orthogonal to the stacking direction with respect to the first overlapping portion 22. The first side is the left side in the plane of paper of FIG. 2. The second non-overlapping portion 33 is located on a second side in the direction orthogonal to the stacking direction with respect to the second overlapping portion 32. The second side is the right side in the plane of paper of FIG. 2. The first non-overlapping portion 23 and the second non-overlapping portion 33 are located on both sides of the line connecting the first overlapping portion 22 and the second overlapping portion 32 in the direction orthogonal to the stacking direction.

When the first electrode 2 and the second electrode 3 pressurize the workpiece 100 in the stacking direction, the first contact surface 21 and the second contact surface 31 overlap with each other in the stacking direction only at the first overlapping portion 22 and the second overlapping portion 32. The first overlapping portion 22 and the second overlapping portion 32 form a pressurizing portion which actually pressurizes the workpiece 100. In the first electrode 2 and the second electrode 3, the portion which actually pressurizes the workpiece 100 is part of the first contact surface 21 and the second contact surface 31. The areas of the first overlapping portion 22 and the second overlapping portion 32 are smaller than the areas of the first contact surface 21 and the second contact surface 31.

The first non-overlapping portion 23 and the second non-overlapping portion 33 do not overlap with each other in the stacking direction. In the exemplary configuration of FIG. 2, the second electrode 3 is not present at a location facing the first non-overlapping portion 23 in the stacking direction, and the first electrode 2 is not present at a location facing the second non-overlapping portion 33 in the stacking direction. When the first electrode 2 and the second electrode 3 pressurize the workpiece 100 in the stacking direction, the first non-overlapping portion 23 and the second non-overlapping portion 33 do not pressurize the workpiece 100. The first non-overlapping portion 23 and the second non-overlapping portion 33 function as a power supply portion which supplies power mainly to the workpiece 100.

A line connecting the first non-overlapping portion 23 and the second non-overlapping portion 33 intersects the line connecting the first overlapping portion 22 and the second overlapping portion 32 (see a one-dot-chain line in FIG. 2) in the vicinity of a joint interface 103 of the workpiece 100. In the workpiece 100, a power distribution path is formed so as to connect the first non-overlapping portion 23 and the second non-overlapping portion 33 (see an arrow indicated by a broken line in FIG. 2).

In this manner, each of the first electrode 2 and the second electrode 3 is separated into the function of pressurizing the workpiece 100 and the function of supplying power to the workpiece 100.

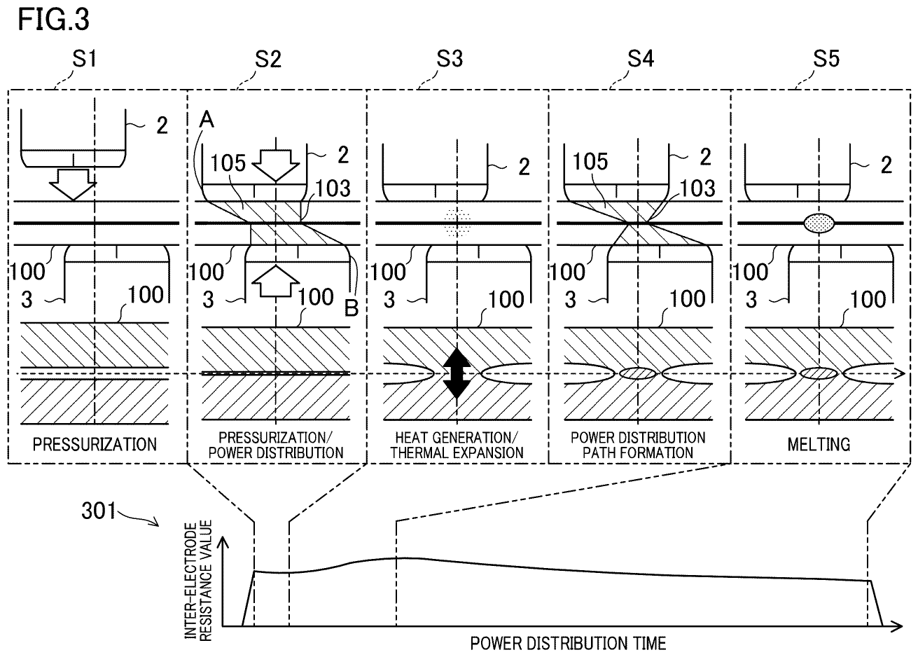

FIG. 3 illustrates, as an example, a welding process by the resistance welding device 1 including the first electrode 2 and the second electrode 3. The welding process includes five steps S1 to S5. The upper part of FIG. 3 illustrates, as an example, a relationship among the first electrode 2, the second electrode 3, and the workpiece 100 in each step, the middle part illustrates, as an example, a state in the vicinity of the joint interface 103 in each step, and the lower part of FIG. 3 illustrates, as an example, a temporal change in an inter-electrode resistance value in the welding process.

A first step S1 is a step of moving the first electrode 2 toward the upper surface of the workpiece 100 in a state in which the second electrode 3 is in contact with the lower surface of the workpiece 100. The first electrode 2 and the second electrode 3 sandwich the workpiece 100 in the stacking direction, and pressurize the workpiece 100 in the stacking direction.

A second step S2 is a step of supplying power to the workpiece 100 with the first electrode 2 and the second electrode 3 while pressurizing the workpiece 100 in the stacking direction with the first electrode 2 and the second electrode 3. At this time, as described above, the first overlapping portion 22 and the second overlapping portion 32 pressurize, as the pressurizing portion, the workpiece 100 in the stacking direction. The two welding target members 101, 102 come into contact with each other at the positions corresponding to the first overlapping portion 22 and the second overlapping portion 32 at the joint interface 103 of the workpiece 100, and accordingly, the power distribution path 105 is formed in the workpiece 100. In the example of FIG. 3, power is supplied not only from the first non-overlapping portion 23 and the second non-overlapping portion 33 but also from the first overlapping portion 22 and the second overlapping portion 32. In this state, the outer peripheral portions A, B of the first electrode 2 and the second electrode 3, which are separated from each other, are present with respect to the power distribution path 105 at the joint interface 103.

A third step S3 is a step of generating Joule heat at positions corresponding to the first overlapping portion 22 and the second overlapping portion 32 at the joint interface 103 of the workpiece 100 and generating thermal expansion at these positions as indicated by a black arrow in FIG. 3. Since the outer peripheral portions A, B are separated from each other, misalignment of the first electrode 2 and the second electrode 3 due to the thermal expansion is reduced.

A fourth step S4 is a step of forming the power distribution path 105 at the joint interface 103 of the workpiece 100 along with the heat generation and the thermal expansion in the third step S3. The power distribution path 105 generates a nugget later. In this state, the power distribution path 105 at the pressurized joint interface 103 is narrowed as compared with the power distribution path 105 in the second step S2 for the pressurization and the power distribution.

A fifth step S5 is a step of melting the welding target members 101, 102 at the joint interface 103 of the workpiece 100 and expanding the power distribution path 105.

Although not illustrated in FIG. 3, after the fifth step S5, the molten welding target members 101, 102 are solidified to form the nugget, and the welding process is completed. Even in the states of the fourth step S4 and the fifth step S5, the misalignment at the outer peripheral portions A, B separated from the nugget is small in response to deformation of the workpiece 100 due to the nugget.

As illustrated in FIG. 2, in each of the first electrode 2 and the second electrode 3, the areas of the first overlapping portion 22 and the second overlapping portion 32 which pressurize the workpiece 100 are relatively small. This reduces the first electrode 2 and the second electrode 3 from sinking into the workpiece 100 when the workpiece 100 is plastically deformed in the fourth step S4 to the fifth step S5.

In other words, the first electrode 2 and the second electrode 3 each have the first non-overlapping portion 23 and the second non-overlapping portion 33. This reduces the first electrode 2 and the second electrode 3 from sinking into the workpiece 100. The first non-overlapping portion 23 and the second non-overlapping portion 33 are each a first reduction portion and a second reduction portion which reduce the sinking into the workpiece 100.

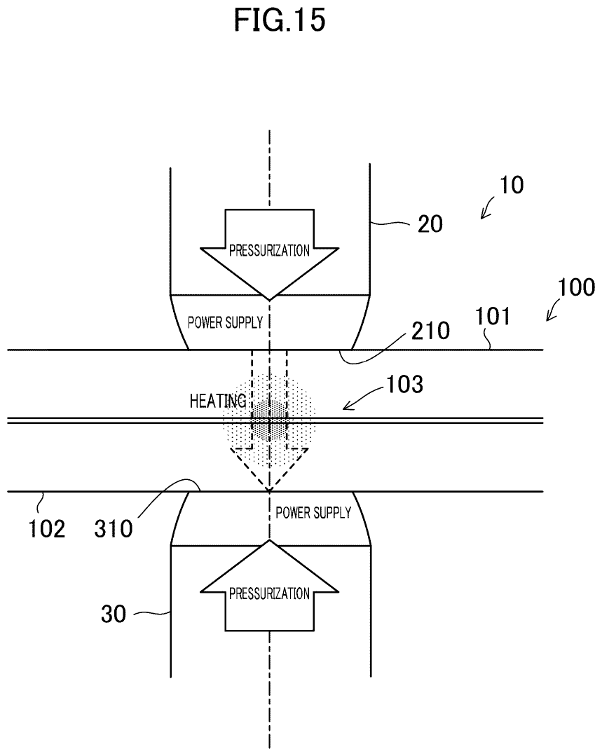

In a conventional resistance welding device 10 illustrated as an example in FIG. 15, a first electrode 20 and a second electrode 30 sink into a workpiece 100, and for this reason, arc discharge occurs between an electrode surface and a workpiece surface, which deteriorates the electrodes.

In the resistance welding device 1 of FIG. 2, the sinking of the first electrode 2 and the second electrode 3 into the workpiece 100 is reduced, and therefore, occurrence of arc discharge between the electrode surface and the workpiece surface is reduced. That is, the deterioration of the electrode is reduced.

The first overlapping portion 22 and the second overlapping portion 32 of the first electrode 2 and the second electrode 3 have relatively-small areas, and therefore, the amount of heat transferred from the workpiece 100 to the first electrode 2 or the second electrode 3 during the welding process is reduced. In addition, the volumes of the first electrode 2 and the second electrode 3 having the first non-overlapping portion 23 and the second non-overlapping portion 33 are relatively high, and therefore, the heat capacity of the first electrode 2 or the second electrode 3 is relatively high. This also reduces, as a result, alloying of the electrode surface and deformation of the electrode surface, which are caused by heating of the first electrode 2 and the second electrode 3 to higher temperatures due to heat from the workpiece 100.

As a result of the reduction in the deterioration of the electrode, the resistance welding device 1 can manage a joint interface state with high accuracy. The high-accuracy management of the joint interface state stabilizes, for example, the welding quality of a multi-material. Further, the deterioration of the electrode is reduced, and therefore, the resistance welding device 1 is advantageous in reducing the frequency of stopping a manufacturing line and reducing a manufacturing cost. Further, it is not necessary to increase the amount of power supplied during welding in advance in consideration of the deterioration of the electrode, and therefore, the resistance welding device 1 can also reduce an energy loss.

The first non-overlapping portion 23 and the second non-overlapping portion 33 are stably in contact with the surface of the workpiece 100 without sinking into the workpiece 100 during the welding process. When the welding target members 101, 102 are thermally expanded in the step S2, the first non-overlapping portion 23 and the second non-overlapping portion 33 press the thermally-expanded welding target members 101, 102. As a result, distortion of the workpiece 100 after completion of welding is reduced.

Here, in each of the first electrode 2 and the second electrode 3, the percentage of the area of the overlapping portion with respect to the entire area of the contact surface may be 10% to 90%. With such a configuration, the sinking of the electrode can be effectively reduced, and therefore, the deterioration of the first electrode 2 and the second electrode 3 can be reduced.

A portion where the line connecting the first overlapping portion 22 and the second overlapping portion 32 and the joint interface of the workpiece 100 intersect is a portion where the welding target members 101, 102 come into contact with each other by the pressurization with the first overlapping portion 22 and the second overlapping portion 32 and the power distribution path is formed accordingly, and this portion is a portion to be welded. The line connecting the first non-overlapping portion 23 and the second non-overlapping portion 33, which supply power to the workpiece 100, intersects the portion to be welded, where the power distribution path is formed, and accordingly, the first electrode 2 and the second electrode 3 can efficiently generate Joule heat at the portion to be welded in the workpiece 100.

The first non-overlapping portion 23 and the second non-overlapping portion 33 are located symmetrically with respect to the line connecting the first overlapping portion 22 and the second overlapping portion 32, and therefore, the first non-overlapping portion 23 and the second non-overlapping portion 33 can efficiently supply power to a portion corresponding to the first overlapping portion 22 and the second overlapping portion 32, where the welding target members 101, 102 come into contact with each other. An energy loss in resistance welding is reduced. Further, the first electrode 2 and the second electrode 3 can stably contact the surface of the workpiece 100.

### Specific Structures of First Electrode and Second Electrode

### (First Example)

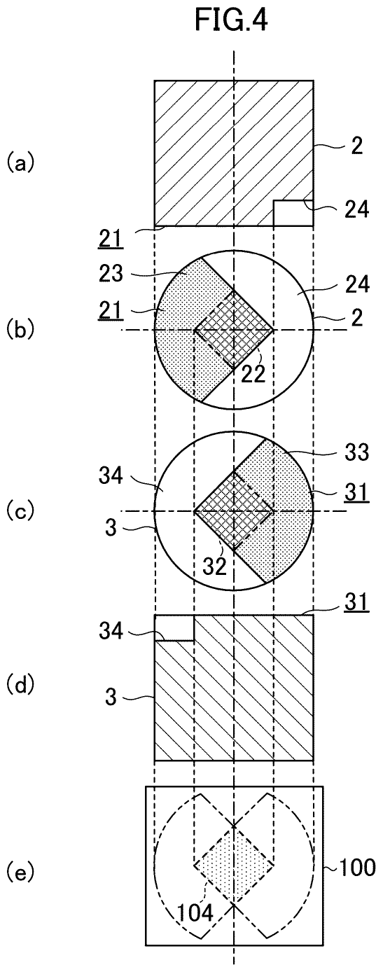

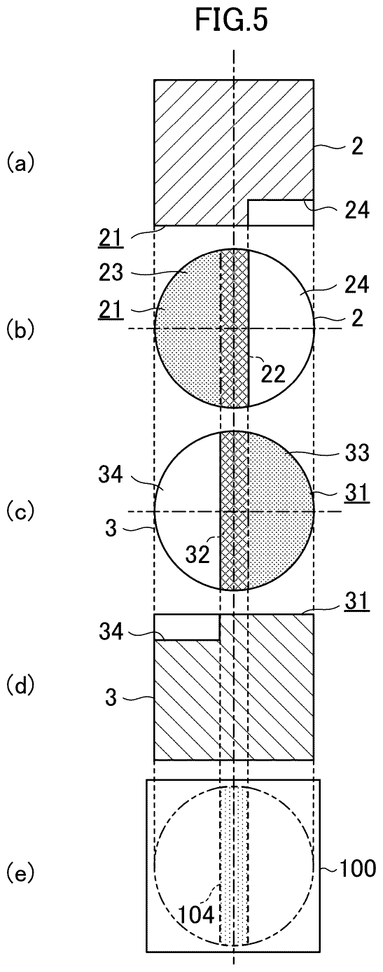

FIG. 4 illustrates, as an example, specific structures of the first electrode 2 and the second electrode 3. In FIG. 4, (a) is a sectional view of the first electrode 2, (b) is a plan view of the first electrode 2, (c) is a plan view of the second electrode 3, (d) is a sectional view of the second electrode 3, and (e) shows the shape of a nugget 104 of the workpiece 100 joined using the first electrode 2 and the second electrode 3. A two-dot chain line in (e) of FIG. 4 is a line obtained by projecting the shapes of the first contact surface 21 and the second contact surface 31 onto the workpiece 100. The same also applies to (a) to (e) of FIGS. 5 to 12 to be described below.

The first electrode 2 and the second electrode 3 each have a columnar shape with the same diameter. The first electrode 2 and the second electrode 3 are coaxial with each other.

The first contact surface 21 of the first electrode 2 and the second contact surface 31 of the second electrode 3 each have a fan-like shape. However, the diameter of the fan-like shape is greater than the diameter of the columnar first electrode 2 and second electrode 3. The axes of the first electrode 2 and the second electrode 3 are located inside the first contact surface 21 and the second contact surface 31.

The first electrode 2 and the second electrode 3 are inverted with respect to the axis. As illustrated in (a) of FIG. 4, a portion of the tip end of the first electrode 2 other than the first contact surface 21 is a first recessed portion 24. Similarly, as illustrated in (d) of FIG. 4, a portion of the tip end of the second electrode 3 other than the second contact surface 31 is a second recessed portion 34. These recessed portions 24, 34 do not contact with the surface of the workpiece 100.

When the first electrode 2 and the second electrode 3 face each other, an overlapping portion of the first contact surface 21 and the second contact surface 31 is a cross-hatched portion in (b) and (d) of FIG. 4, and is a quadrangular portion including the axis. Such a portion is the first overlapping portion 22 and the second overlapping portion 32. In addition, portions of the first contact surface 21 and the second contact surface 31 other than the first overlapping portion 22 and the second overlapping portion 32 are the first non-overlapping portion 23 and the second non-overlapping portion 33. The first non-overlapping portion 23 and the second non-overlapping portion 33 do not overlap with each other in the stacking direction.

The first non-overlapping portion 23 is located on the first side in the direction orthogonal to the stacking direction with respect to the first overlapping portion 22, and the second non-overlapping portion 33 is located on the second side in the direction orthogonal to the stacking direction with respect to the second overlapping portion 32. The first non-overlapping portion 23 and the second non-overlapping portion 33 are symmetrically located on both sides of the line connecting the first overlapping portion 22 and the second overlapping portion 32 in the direction orthogonal to the stacking direction.

With the first electrode 2 and the second electrode 3 of FIG. 4, the substantially-quadrangular nugget 104 is formed in the workpiece 100.

### (Second Example)

The first electrode 2 of FIG. 5 has the first contact surface 21 shaped like a semicircular shape, and the second electrode 3 has the second contact surface 31 shaped like a semicircular shape as in the first electrode 2. The first electrode 2 and the second electrode 3 are inverted with respect to the axis. As illustrated in (a) of FIG. 5, a portion of the tip end of the first electrode 2 other than the first contact surface 21 is a first recessed portion 24. Similarly, as illustrated in (d) of FIG. 5, a portion of the tip end of the second electrode 3 other than the second contact surface 31 is a second recessed portion 34. These recessed portions 24, 34 do not contact with the surface of the workpiece 100.

When the first electrode 2 and the second electrode 3 face each other, an overlapping portion of the first contact surface 21 and the second contact surface 31 is a cross-hatched portion in (b) and (c) of FIG. 5, and is a linear portion including the axis. Such a portion is the first overlapping portion 22 and the second overlapping portion 32. In addition, portions of the first contact surface 21 and the second contact surface 31 other than the first overlapping portion 22 and the second overlapping portion 32 are the first non-overlapping portion 23 and the second non-overlapping portion 33. The first non-overlapping portion 23 and the second non-overlapping portion 33 do not overlap with each other in the stacking direction.

The first non-overlapping portion 23 is located on the first side in the direction orthogonal to the stacking direction with respect to the first overlapping portion 22, and the second non-overlapping portion 33 is located on the second side in the direction orthogonal to the stacking direction with respect to the second overlapping portion 32. The first non-overlapping portion 23 and the second non-overlapping portion 33 are symmetrically located on both sides of the line connecting the first overlapping portion 22 and the second overlapping portion 32 in the direction orthogonal to the stacking direction.

With the first electrode 2 and the second electrode 3 of FIG. 5, the linear nugget 104 is formed in the workpiece 100. The nugget 104 has directionality. The expression “having directionality” means that the length of the nugget 104 in a first direction is sufficiently longer than the length of the nugget 104 in a second direction. By properly setting the direction of the nugget 104 in accordance with the workpiece 100, it is possible to ensure required strength. Further, the nugget 104 has a narrow width in the right-left direction in the plane of paper of FIG. 5, and therefore, a narrow portion of the workpiece 100 can be welded. The linear nugget 104 has an advantage that the width of a flange to be welded can be narrowed, for example. The width of the nugget 104 can be adjusted as appropriate by adjusting the widths of the first overlapping portion 22 and the second overlapping portion 32.

### (Third Example)

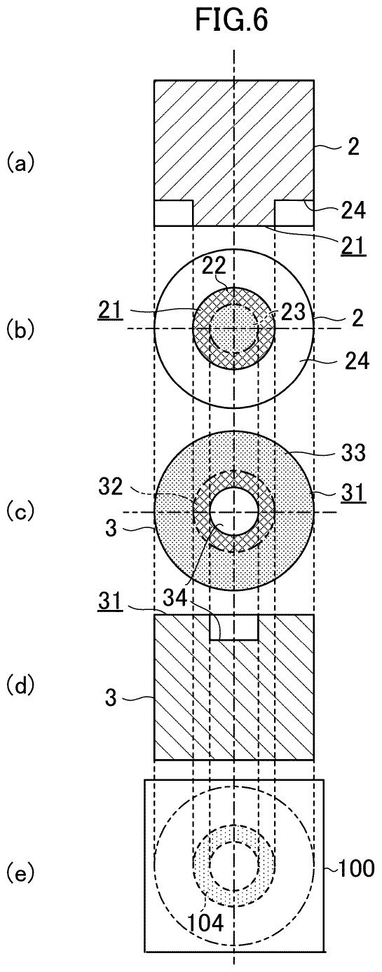

The first electrode 2 of FIG. 6 has the first contact surface 21 in a circular shape, and the second electrode 3 has the second contact surface 31 in a circular ring shape unlike the first electrode 2. In the example of FIG. 6, the first contact surface 21 and the second contact surface 31 have different shapes. The shape of the first contact surface 21 of the first electrode 2 and the shape of the second contact surface 31 of the second electrode 3 may be interchanged. As illustrated in (a) of FIG. 6, a portion of the tip end of the first electrode 2 other than the first contact surface 21 is a first recessed portion 24. Similarly, as illustrated in (d) of FIG. 6, a portion of the tip end of the second electrode 3 other than the second contact surface 31 is a second recessed portion 34. These recessed portions 24, 34 do not contact with the surface of the workpiece 100.

When the first electrode 2 and the second electrode 3 face each other, an overlapping portion of the first contact surface 21 and the second contact surface 31 is a cross-hatched portion in (b) and (c) of FIG. 6, and is a circular ring portion about the axis. Such a portion is the first overlapping portion 22 and the second overlapping portion 32. The first overlapping portion 22 has a circular ring shape located at an outer peripheral portion of the first contact surface 21. The second overlapping portion 32 has a circular ring shape located at an inner peripheral portion of the second contact surface 31. In addition, a circular portion of the first contact surface 21 located inside the first overlapping portion 22 is the first non-overlapping portion 23, and a circular ring portion of the second contact surface 31 located outside the second overlapping portion 32 is the second non-overlapping portion 33. The first non-overlapping portion 23 and the second non-overlapping portion 33 do not overlap with each other in the stacking direction.

The first non-overlapping portion 23 is located on the first side in the direction orthogonal to the stacking direction with respect to the first overlapping portion 22, i.e., inside in the radial direction, in the section illustrated in (a) of FIG. 6, and the second non-overlapping portion 33 is located on the second side in the direction orthogonal to the stacking direction with respect to the second overlapping portion 32, i.e., outside in the radial direction, in the section illustrated in (d) of FIG. 6. The first non-overlapping portion 23 and the second non-overlapping portion 33 are located on both sides of the line connecting the first overlapping portion 22 and the second overlapping portion 32 in the direction orthogonal to the stacking direction.

With the first electrode 2 and the second electrode 3 of FIG. 6, the circular ring-shaped nugget 104 is formed in the workpiece 100.

### (Fourth Example)

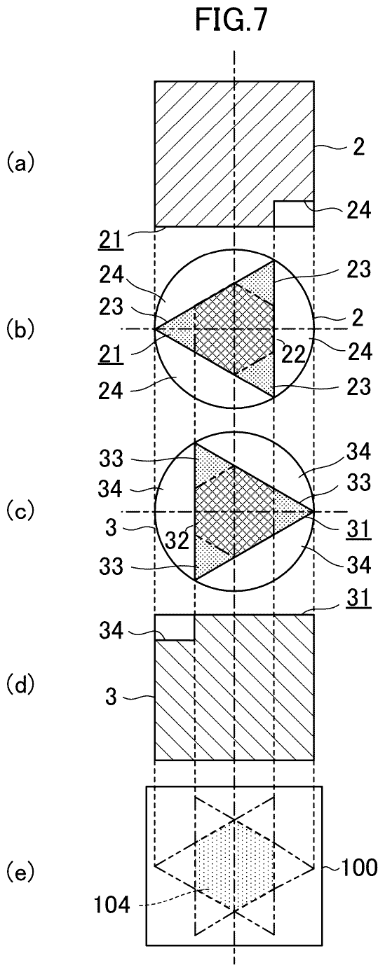

The first electrode 2 of FIG. 7 has the first contact surface 21 in a triangular shape, and the second electrode 3 has the second contact surface 31 in a triangular shape as in the first electrode 2. More precisely, the first contact surface 21 and the second contact surface 31 are in the regular triangular shape. The first electrode 2 and the second electrode 3 are inverted with respect to the axis. The first contact surface 21 and the second contact surface 31 are located such that the centers of gravity of the triangles overlap with each other in the stacking direction. As illustrated in (a) of FIG. 7, a portion of the tip end of the first electrode 2 other than the first contact surface 21 is a first recessed portion 24. Similarly, as illustrated in (d) of FIG. 7, a portion of the tip end of the second electrode 3 other than the second contact surface 31 is a second recessed portion 34. These recessed portions 24, 34 do not contact with the surface of the workpiece 100.

When the first electrode 2 and the second electrode 3 face each other, an overlapping portion of the first contact surface 21 and the second contact surface 31 is a cross-hatched portion in (b) and (c) of FIG. 7, and is a regular hexagonal portion about the axis. Such a portion is the first overlapping portion 22 and the second overlapping portion 32. In addition, three triangular portions of the first contact surface 21 other than the first overlapping portion 22, i.e., portions in the vicinity of the vertices of the triangle, are the first non-overlapping portions 23, and three triangular portions of the second contact surface 31 other than the second overlapping portion 32, i.e., portions in the vicinity of the vertices of the triangle, are the second non-overlapping portions 33. All the three first non-overlapping portions 23 and the three second non-overlapping portions 33 do not overlap with each other in the stacking direction. The first electrode 2 and the second electrode 3 of FIG. 7 have the first non-overlapping portions 23 and the second non-overlapping portions 33.

With the first electrode 2 and the second electrode 3 of FIG. 7, the hexagonal nugget 104 is formed in the workpiece 100.

When the first electrode 2 and the second electrode 3 pressurize the workpiece 100 in the stacking direction, applied pressure at a portion corresponding to a portion where the edge of the first contact surface 21 and the edge of the second contact surface 31 overlap with each other is likely to increase at the joint interface of the workpiece, and the power distribution path is formed at this portion and Joule heat is likely to be generated. In the electrodes of FIG. 7, Joule heat is likely to be generated at each vertex of the hexagon of the first overlapping portion 22 and the second overlapping portion 32, and therefore, a large number of heat generation portions are arranged uniformly in the circumferential direction around the axis. The portion to be welded can be uniformly heated from the periphery thereof, and therefore, the electrodes of FIG. 7 have an advantage that the heating of the workpiece 100 is stabilized.

Further, the multiple first non-overlapping portions 23 and the multiple second non-overlapping portions 33 are arranged at equal intervals around the first overlapping portion 22 and the second overlapping portion 32, and therefore, when the workpiece 100 is thermally expanded, the first non-overlapping portions 23 and the second non-overlapping portions 33 can effectively press the thermally-expanded welding target members.

The shapes of the first contact surface 21 and the second contact surface 31 are not limited to the shape of the equilateral triangle. The first contact surface 21 and the second contact surface 31 may have, for example, the shape of an isosceles triangle. The first contact surface 21 and the second contact surface 31 may have a polygonal shape other than the triangular shape.

### (Fifth Example)

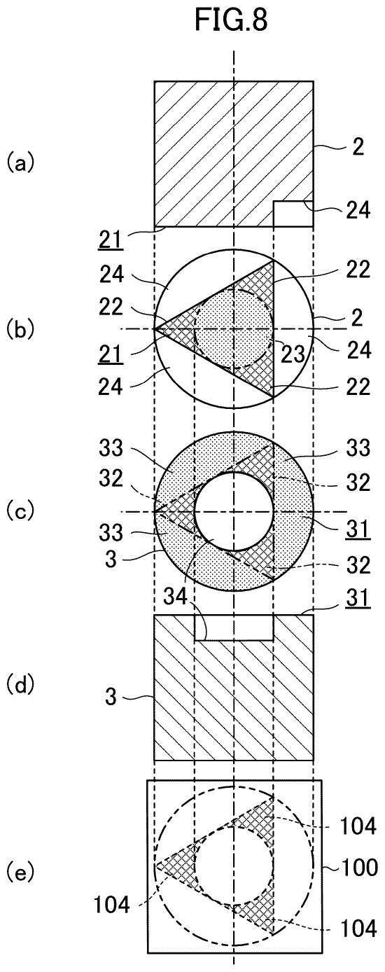

The electrodes of FIG. 8 are a combination of those of the third and fourth examples. That is, the first electrode 2 has the triangular first contact surface 21 as in the fourth example. The second electrode 3 has the circular ring-shaped second contact surface 31 as in the third example. The outer diameter of the second contact surface 31 coincides with the diameter of the circumscribed circle of the triangle of the first contact surface 21, and the inner diameter of the second contact surface 31 coincides with the diameter of the inscribed circle of the triangle of the first contact surface 21.

When the first electrode 2 and the second electrode 3 face each other, an overlapping portion of the first contact surface 21 and the second contact surface 31 is a cross-hatched portion in (b) and (c) of FIG. 8, and is a portion in the vicinity of each vertex of the triangle. All these portions are the first overlapping portions 22 and the second overlapping portions 32. The first electrode 2 and the second electrode 3 of FIG. 8 have the multiple first overlapping portions 22 and the multiple second overlapping portions 32. In addition, an inscribed circle portion of the first contact surface 21 other than the first overlapping portions 22 is the first non-overlapping portion 23, and portions (i.e., arched portions) of the circle of the second contact surface 31 other than the second overlapping portions 32 are the second non-overlapping portions 33. All the first non-overlapping portion 23 and the three second non-overlapping portions 33 do not overlap with each other in the stacking direction.

With the first electrode 2 and the second electrode 3 of FIG. 8, multiple nuggets 104 are formed in the workpiece 100.

The relationship between the triangle of the first contact surface 21 and the circular ring of the second contact surface 31 is not limited to the above-described relationship between the circumscribed circle and the inscribed circle of the triangle.

The first contact surface 21 of the first electrode 2 is not limited to the triangle, and may be another polygon.

Further, the shape of the first electrode 2 and the shape of the second electrode 3 may be interchanged.

### (Sixth Example)

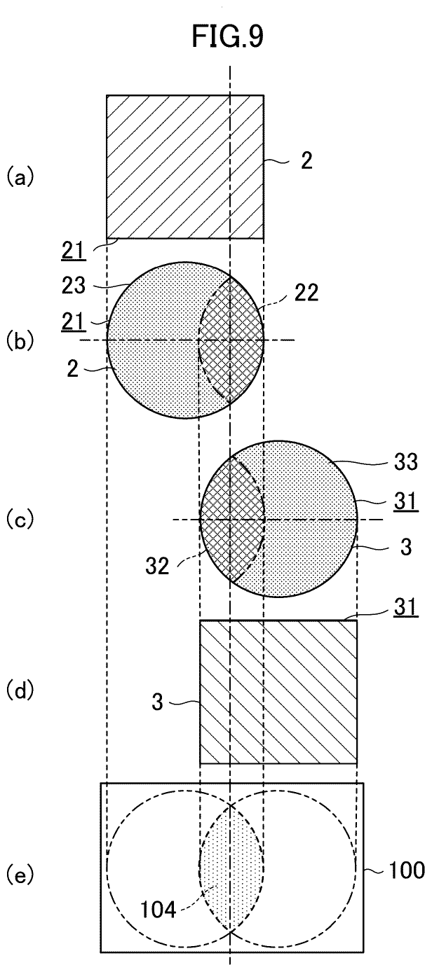

The first electrode 2 of FIG. 9 has the first contact surface 21 in a circular shape, and the second electrode 3 has the second contact surface 31 in a circular shape as in the first electrode 2. In both the first electrode 2 and the second electrode 3, the entire tip end surface of the columnar electrode is a contact surface.

The first electrode 2 and the second electrode 3 are not arranged coaxial with each other. The first electrode 2 and the second electrode 3 face each other such that the first contact surface 21 and the second contact surface 31 partially overlap with each other. The overlapping portion of the first contact surface 21 and the second contact surface 31 is a cross-hatched portion in (b) and (c) of FIG. 9, which has an elliptical-like shape. Such a portion is the first overlapping portion 22 and the second overlapping portion 32. In addition, portions of the first contact surface 21 and the second contact surface 31 other than the first overlapping portion 22 and the second overlapping portion 32 are the first non-overlapping portion 23 and the second non-overlapping portion 33. The first non-overlapping portion 23 and the second non-overlapping portion 33 do not overlap with each other in the stacking direction.

The first non-overlapping portion 23 is located on the first side in the direction orthogonal to the stacking direction with respect to the first overlapping portion 22, and the second non-overlapping portion 33 is located on the second side in the direction orthogonal to the stacking direction with respect to the second overlapping portion 32. The first non-overlapping portion 23 and the second non-overlapping portion 33 are symmetrically located on both sides of the line connecting the first overlapping portion 22 and the second overlapping portion 32 in the direction orthogonal to the stacking direction.

With the first electrode 2 and the second electrode 3 of FIG. 9, a substantially-elliptical nugget 104 is formed in the workpiece 100.

The first contact surface 21 and the second contact surface 31 are not limited to the circular shape, and may be, for example, an elliptical shape. The elliptical first contact surface 21 and second contact surface 31 may partially overlap with each other in the major axis direction thereof, or may partially overlap with each other in the minor axis direction thereof.

### (Seventh Example)

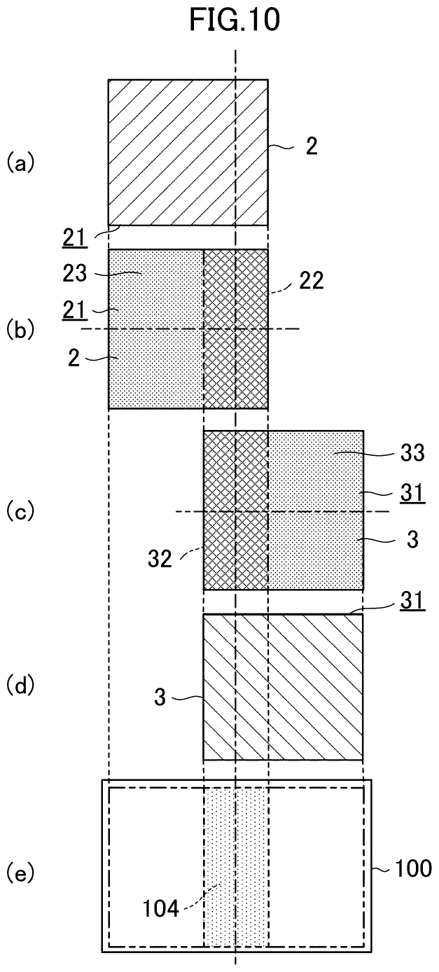

The first electrode 2 of FIG. 10 has the first contact surface 21 in a quadrangular shape, and the second electrode 3 has the second contact surface 31 in a quadrangular shape as in the first electrode 2. In both the first electrode 2 and the second electrode 3, the entire tip end surface of the quadrangular columnar electrode is a contact surface.

The first electrode 2 and the second electrode 3 are not arranged coaxial with each other. The first electrode 2 and the second electrode 3 face each other such that the first contact surface 21 and the second contact surface 31 partially overlap with each other. The overlapping portion of the first contact surface 21 and the second contact surface 31 is a cross-hatched portion in (b) and (c) of FIG. 10, and is a rectangular portion. Such a portion is the first overlapping portion 22 and the second overlapping portion 32. In addition, portions of the first contact surface 21 and the second contact surface 31 other than the first overlapping portion 22 and the second overlapping portion 32 are the first non-overlapping portion 23 and the second non-overlapping portion 33. The first non-overlapping portion 23 and the second non-overlapping portion 33 do not overlap with each other in the stacking direction.

The first non-overlapping portion 23 is located on the first side in the direction orthogonal to the stacking direction with respect to the first overlapping portion 22, and the second non-overlapping portion 33 is located on the second side in the direction orthogonal to the stacking direction with respect to the second overlapping portion 32. The first non-overlapping portion 23 and the second non-overlapping portion 33 are symmetrically located on both sides of the line connecting the first overlapping portion 22 and the second overlapping portion 32 in the direction orthogonal to the stacking direction.

With the first electrode 2 and the second electrode 3 of FIG. 10, the rectangular nugget 104 is formed in the workpiece 100. In this case, the nugget 104 also has directionality as in the second example described above.

### (Eighth Example)

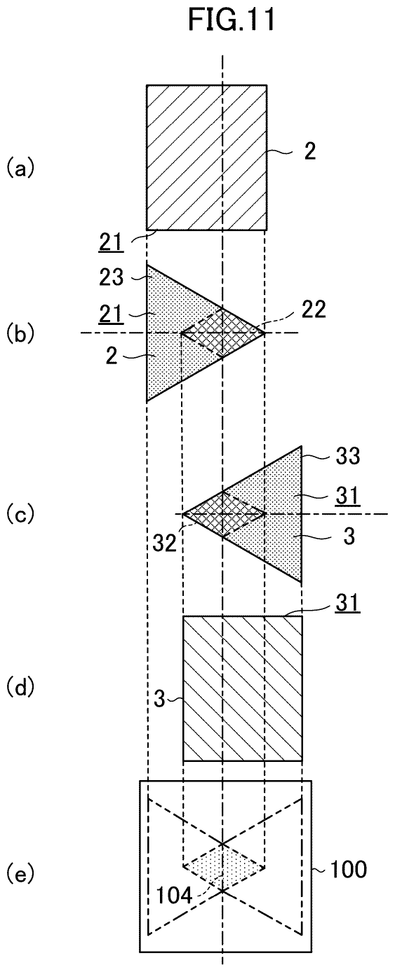

The first electrode 2 of FIG. 11 has the first contact surface 21 in a triangular shape, and the second electrode 3 has the second contact surface 31 in a triangular shape as in the first electrode 2. In both the first electrode 2 and the second electrode 3, the entire tip end surface of the triangular columnar electrode is a contact surface. The orientations of the first electrode 2 and the second electrode 3 are inverted with respect to the axis.

The first electrode 2 and the second electrode 3 are not arranged coaxial with each other. The first electrode 2 and the second electrode 3 face each other such that the first contact surface 21 and the second contact surface 31 partially overlap with each other. More specifically, the first contact surface 21 and the second contact surface 31 partially overlap with each other in the vicinity of their vertices. The overlapping portion of the first contact surface 21 and the second contact surface 31 is a cross-hatched portion in (b) and (c) of FIG. 11, and is a rhombic portion. Such a portion is the first overlapping portion 22 and the second overlapping portion 32. In addition, portions of the first contact surface 21 and the second contact surface 31 other than the first overlapping portion 22 and the second overlapping portion 32 are the first non-overlapping portion 23 and the second non-overlapping portion 33. The first non-overlapping portion 23 and the second non-overlapping portion 33 do not overlap with each other in the stacking direction.

The first non-overlapping portion 23 is located on the first side in the direction orthogonal to the stacking direction with respect to the first overlapping portion 22, and the second non-overlapping portion 33 is located on the second side in the direction orthogonal to the stacking direction with respect to the second overlapping portion 32. The first non-overlapping portion 23 and the second non-overlapping portion 33 are symmetrically located on both sides of the line connecting the first overlapping portion 22 and the second overlapping portion 32 in the direction orthogonal to the stacking direction.

With the first electrode 2 and the second electrode 3 of FIG. 11, the rhombic nugget 104 is formed in the workpiece 100.

The first contact surface 21 and the second contact surface 31 are not limited to the quadrangular shape of the seventh example or the triangular shape of the eighth example, and may be other polygonal shapes or regular polygonal shapes.

### (Ninth Example)

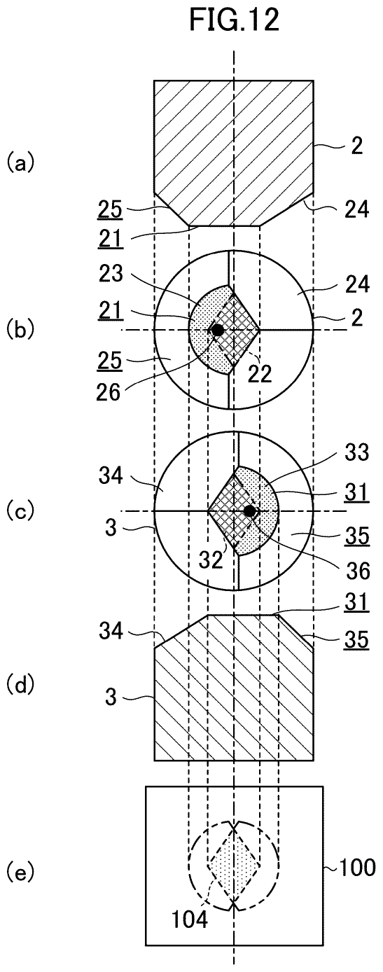

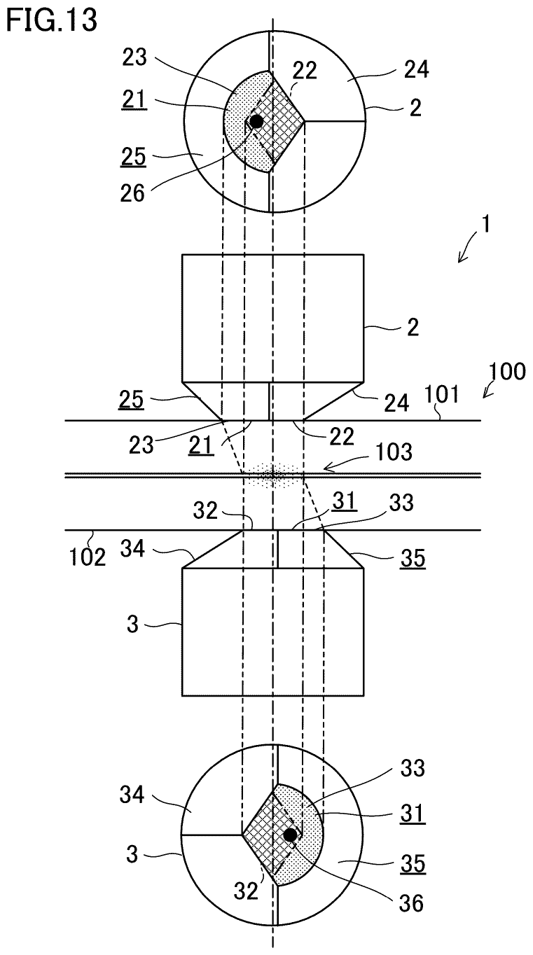

FIGS. 12 and 13 illustrate a modification of the electrodes illustrated in FIG. 4. The first contact surface 21 of the first electrode 2 and the second contact surface 31 of the second electrode 3 each have a fan-like shape. However, the diameter of the fan-like shape is smaller than the diameter of the fan-like shape of the first contact surface 21 and the second contact surface 31 of the electrodes of FIG. 4.

More specifically, the first contact surface 21 of the first electrode 2 of FIG. 4 extends to the peripheral edge of the first electrode 2. Similarly, the second contact surface 31 of the second electrode 3 of FIG. 4 extends to the peripheral edge of the second electrode 3.

On the other hand, the first electrode 2 of FIG. 12 is provided with an inclined surface 25. The inclined surface 25 is formed inclined with respect to the axis of the first electrode 2 between the peripheral edge of the first electrode 2 and the first contact surface 21. With the inclined surface 25, the area of the first contact surface 21 is reduced, and the center of gravity 26 of the fan-shaped first contact surface 21 is located closer to the center of the first electrode 2.

Similarly, the second electrode 3 of FIG. 12 is provided with an inclined surface 35. With the inclined surface 35, the area of the second contact surface 31 is reduced, and the center of gravity 36 of the fan-shaped second contact surface 31 is located closer to the center of the second electrode 3.

A recessed portion 24 of the first electrode 2 of FIG. 12 is formed of the surface inclined with respect to the axis of the first electrode 2, and a recessed portion 34 of the second electrode 3 is also formed of the surface inclined with respect to the axis of the second electrode 3.

When the first electrode 2 and the second electrode 3 of FIG. 12 face each other, an overlapping portion of the first contact surface 21 and the second contact surface 31 is a cross-hatched portion in (b) and (c) of FIG. 12, and is a quadrangular portion including the axis. Such a portion is the first overlapping portion 22 and the second overlapping portion 32. In addition, portions of the first contact surface 21 and the second contact surface 31 other than the first overlapping portion 22 and the second overlapping portion 32 are the first non-overlapping portion 23 and the second non-overlapping portion 33. The first non-overlapping portion 23 and the second non-overlapping portion 33 do not overlap with each other in the stacking direction.

As described above, the areas of the first contact surface 21 and the second contact surface 31 of the electrodes of FIG. 12 are smaller than the areas of the first contact surface 21 and the second contact surface 31 of the electrodes of FIG. 4, and therefore, the areas of the first non-overlapping portion 23 and the second non-overlapping portion 33 are also relatively small. When the workpiece 100 is supplied with power through the first electrode 2 and the second electrode 3, a current density increases as the areas of the first non-overlapping portion 23 and the second non-overlapping portion 33 decrease, if the same current is applied (see a broken line in FIG. 13). A high current density improves the joint quality of the workpiece 100. The high current density also allows efficient heating of the joint interface of the workpiece 100. The first electrode 2 and the second electrode 3 of FIG. 12 are advantageous in power saving in the resistance welding.

The position of the center of gravity 26 of the first contact surface 21 is close to the center of the first electrode 2, and therefore, the center of gravity 26 is included in the first overlapping portion 22. The position of the center of gravity 36 of the second contact surface 31 is also close to the center of the second electrode 2, and therefore, the center of gravity 36 is included in the second overlapping portion 32 (see (b) and (c) of FIG. 12). The first contact surface 21 and the second contact surface 31 have relatively-small areas and the positions of the centers of gravity 26, 36 thereof are close to the centers of the first electrode 2 and the second electrode 3, and therefore, a pressure density increases when the first electrode 2 and the second electrode 3 pressurize the workpiece 100 in the stacking direction. A high pressure density improves the joint quality of the workpiece 100.

The distances between the positions of the centers of gravity 26, 36 and the center axes of the electrodes 2, 3 are short, and therefore, when the workpiece 100 is softened and melted by heat, moments acting on the first electrode 2 and the second electrode 3 are small. The small moments reduce the electrodes 2, 3 from slipping on the surface of the workpiece 100 and tilting with respect to the surface of the workpiece 100, and reduce the deterioration of the first electrode 2 and the second electrode 3.

Here, if the areas of the first contact surface 21 and the second contact surface 31 are too small, the areas of the first non-overlapping portion 23 and the second non-overlapping portion 33 are too small, and the pressurization function and the power supply function of the first electrode 2 and the second electrode 3 are not substantially separated. The area of the first contact surface 21 may be 120% or more of the area of the first overlapping portion 22. Similarly, the area of the second contact surface 31 may be 120% or more of the area of the second overlapping portion 32. With this configuration, the resistance welding device 10 can obtain the above-described features and effects and have a high current density by separating the pressurization function and the power supply function of the first electrode 2 and the second electrode 3. If the area of the first contact surface 21 is too large with respect to the area of the first overlapping portion 22, the position of the center of gravity of the first contact surface 21 deviates from the first overlapping portion 22. The upper limit of the area of the first contact surface 21 is determined by such a limitation that the position of the center of gravity thereof is included in the first overlapping portion 22. Similarly, the upper limit of the area of the second contact surface 31 is determined by such a limitation that the position of the center of gravity thereof is included in the second overlapping portion 32.

### Examples

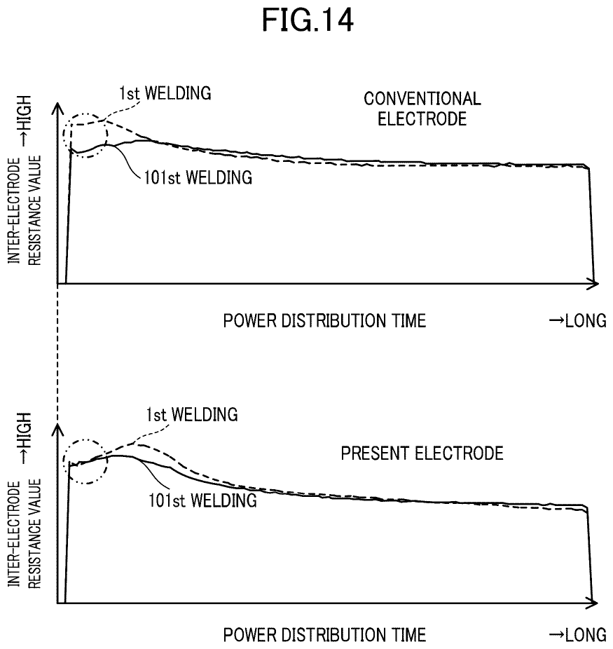

FIG. 14 illustrates an example where the effect of reducing the deterioration of the electrodes was confirmed. The upper part of FIG. 14 illustrates a comparison between the temporal change in the inter-electrode resistance value in first welding and the temporal change in the inter-electrode resistance value in 101st welding when spot welding is repeated using the conventional electrodes illustrated in FIG. 15. The lower part of FIG. 14 illustrates a comparison between the temporal change in the inter-electrode resistance value in first welding and the temporal change in the inter-electrode resistance value in 101st welding when spot welding is repeated using the present electrodes illustrated in FIG. 4.

The upper part of FIG. 14 shows that in the conventional electrodes, the inter-electrode resistance value at an initial stage of welding in the 101st welding was significantly lower than the inter-electrode resistance value at an initial stage of welding in the first welding. The decrease in the inter-electrode resistance value was caused by the deterioration of the electrodes caused by the repetition of the spot welding.

On the other hand, the lower part of FIG. 14 shows that in the present electrodes, the inter-electrode resistance value at an initial stage of welding in the 101st welding did not change much from the inter-electrode resistance value at an initial stage of welding in the first welding. That is, the deterioration of the present electrodes was reduced.

As a standard of the pressure density or the current density in the resistance welding, a standard formulated by Resistance Welding Manufacturing Alliance (RWMA) has been known. Also in the resistance welding using the electrodes of the first to ninth examples described above, the pressure density or the current density may be determined in accordance with the RWMA standard.

Specifically, in the resistance welding device 1 disclosed herein, the pressure density may be 4 kgf/mm² to 10 kgf/mm². The current density may be 200 A/mm² to 500 A/mm².

The foregoing embodiments are merely preferred examples in nature, and the scope of the present invention should not be interpreted in a limited manner. The scope of the present invention is defined by the appended claims, and all variations and modifications belonging to a range equivalent to the range of the claims are within the scope of the present invention.

### DESCRIPTION OF REFERENCE CHARACTERS

1 Resistance Welding Device
100 Workpiece
101,102 Welding Target Member
103 Joint Interface
2 First Electrode
21 First Contact Surface
22 First Overlapping Portion
23 First Non-Overlapping Portion (First Reduction Portion)
26 Center of Gravity
3 Second Electrode
31 Second Contact Surface
32 Second Overlapping Portion
33 Second Non-Overlapping Portion (Second Reduction Portion)
36 Center of Gravity

1. A resistance welding device for welding multiple stacked welding target members of a workpiece by pressurizing the workpiece in a stacking direction while supplying power to the workpiece, the resistance welding device comprising:
a first electrode located on a first side in the stacking direction with respect to the workpiece; and
a second electrode located on a second side in the stacking direction with respect to the workpiece and sandwiching the workpiece together with the first electrode,
the first electrode having a first contact surface in contact with the workpiece,
the second electrode having a second contact surface in contact with the workpiece,
the first contact surface having at least one first overlapping portion and at least one first non-overlapping portion,
the second contact surface having at least one second overlapping portion and at least one second non-overlapping portion,
the first overlapping portion and the second overlapping portion overlapping with each other in the stacking direction, the first non-overlapping portion and the second non-overlapping portion not overlapping with each other in the stacking direction.

2. The resistance welding device of claim 1, wherein
a line connecting the first non-overlapping portion and the second non-overlapping portion intersects a line connecting the first overlapping portion and the second overlapping portion in a vicinity of a joint interface of the workpiece.

3. The resistance welding device of claim 2, wherein
the first non-overlapping portion is located on a first side in a direction orthogonal to the stacking direction with respect to the first overlapping portion, and the second non-overlapping portion is located on a second side in the direction orthogonal to the stacking direction with respect to the second overlapping portion, and
the first non-overlapping portion and the second non-overlapping portion are located on both sides of a line connecting the first overlapping portion and the second overlapping portion in the direction orthogonal to the stacking direction.

4. The resistance welding device of claim 2, wherein
the first contact surface has a circular shape, and the second contact surface has a circular ring shape concentric with the first contact surface,
the first overlapping portion has a circular ring shape located at an outer peripheral portion of the first contact surface, and the first non-overlapping portion has a circular shape located inside the circular ring-shaped first overlapping portion, and
the second overlapping portion has a circular ring shape located at an inner peripheral portion of the second contact surface, and the second non-overlapping portion has a circular ring shape located outside the circular ring-shaped second overlapping portion.

5. The resistance welding device of claim 1, wherein
the first contact surface has a triangular shape, and the second contact surface has a triangular shape obtained by inverting a direction of a triangle of the first contact surface with respect to a line connecting the first overlapping portion and the second overlapping portion, and
the first contact surface and the second contact surface are located such that centers of gravity of the triangles thereof overlap with each other in the stacking direction.

6. The resistance welding device of claim 1, wherein
a position of a center of gravity of the first contact surface is included in the first overlapping portion, and
a position of a center of gravity of the second contact surface is included in the second overlapping portion.

7. The resistance welding device of claim 6, wherein
an area of the first contact surface is 120% or more of an area of the first overlapping portion, and
an area of the second contact surface is 120% or more of an area of the second overlapping portion.

8. A resistance welding device for welding multiple stacked welding target members of a workpiece by pressurizing the workpiece in a stacking direction while supplying power to the workpiece, the resistance welding device comprising:
a first electrode located on a first side in the stacking direction with respect to the workpiece and having a first contact surface in contact with the workpiece; and
a second electrode located on a second side in the stacking direction with respect to the workpiece, having a second contact surface in contact with the workpiece, and sandwiching the workpiece together with the first electrode,
the first electrode having, at part of the first contact surface, a first reduction portion configured to reduce sinking into the workpiece during power supply,
the second electrode having, at part of the second contact surface, a second reduction portion configured to reduce sinking into the workpiece during power supply.

9. A resistance welding method for welding, using a first electrode and a second electrode, multiple stacked welding target members of a workpiece by pressurizing the workpiece in a stacking direction while supplying power to the workpiece,
the first electrode having a first contact surface that is in contact with the workpiece and includes at least one first overlapping portion and at least one first non-overlapping portion,
the second electrode having a second contact surface that is in contact with the workpiece and includes at least one second overlapping portion and at least one second non-overlapping portion,
the first overlapping portion and the second overlapping portion overlapping with each other in the stacking direction, the first non-overlapping portion and the second non-overlapping portion not overlapping with each other in the stacking direction, the resistance welding method comprising:
pressurizing the workpiece in the stacking direction with the first overlapping portion and the second overlapping portion; and
supplying power to the workpiece with at least the first non-overlapping portion and the second non-overlapping portion.
